(19) United States
(12) Patent Application Publication
(10) Pub. No.: US 2014/0331880 A1
(43) Pub. Date: Nov. 13, 2014

(54) CLOSED-LOOP CONTROL OF UNTENSIONED PRODUCT LENGTH ON A WEB PRESS

(71) Applicant: Goss International Americas Inc., Durham, NH (US)

(72) Inventors: Douglas Joseph DAWLEY, Dover, NH (US); Daniel Matthew Perdue, Rochester, NH (US); Drew Edwin Kiefaber, Newmarket, NH (US)

(73) Assignee: Goss International Americas Inc., Durham, NH (US)

(21) Appl. No.: 13/890,485

(22) Filed: May 9, 2013

(51) Int. Cl. B41F 21/00

(52) U.S. Cl. CPC B41F 21/00
USPC 101/481; 101/485

(57) ABSTRACT

A system and method is provided for closed loop control of an untensioned product length of a web moving through a printing press under tension during production. While a printing press is printing on the web, a controller receives a calculated untensioned product length Lₒ(t) of the web in the span of the printing press while the web is moving through the printing press under tension, compares L₀(t) to a previously stored untensioned product length setpoint Lₛₑₜₚₒᵢₙₜ, maintains closed loop control of the untensioned product length by controlling one or more components on the printing press as a function of said comparing step, and repeats the steps receiving, comparing, maintaining and controlling over time while the printing press is printing on the web.

This application relates to a system and method for controlling untensioned product length of a web in a printing press.

This application is related to co-owned U.S. patent application Ser. No. ______, entitled SYSTEM AND METHOD FOR MEASURING UNTENSIONED PRODUCT LENGTH OF A WEB DURING PRODUCTION, attorney docket number [6003.1279, HEM 2013/601], filed on even date herewith, the entire disclosure of which is hereby incorporated by reference.

### BACKGROUND INFORMATION

There is a need in the web press industry to control the length of the final, untensioned product. This is especially important when working with thin, low-stiffness substrates that are used, for example, in the packaging industry. In general, thin, low-stiffness substrates have a thickness of from about 0.0003 to about 0.0030 inches, and a tensile stiffness below about 500 lbs. per inch. Nonlimiting examples of such materials are PET film (0.00048 inches, 360 lb./inch), EUR70 film (0.0026 inches, 423 lb./inch), and BOPP film (0.0009 inches, 223 lb./inch).

In order to control the untensioned product length it must first be measured. In today's industry, the untensioned product length is sometimes measured directly. This can be accomplished by cutting a sample from the web, laying it out flat and untensioned on a table, and measuring it with a mechanical or video measurement system.

Attempts have also been made to define the untensioned product length by estimating the amount that a given substrate will “snap back” when process tensions are removed. One example of this appears to be the Muller Martini “Stretch Correct” system, as described in a technical article entitled “Web-offset to gain new fields of application: StretchCorrect—a striking innovation for film printing”, in NarroWebTech 4-2009, pages 12-14 (November 2009).

TecScan's Web Ranger system claims to “display in real time print length measurements of every repeat”. TecScan Web Ranger Brocure (2005). Assuming arguendo that this system works as described, it is believed to at most be able to approximate the repeat length of a strained (tensioned) web only.

### BRIEF SUMMARY OF THE INVENTION

In accordance with a first embodiment of the present invention, a system and method for providing closed loop control of an untensioned product length of a web moving through a printing press under tension during production is provided. In accordance with this system and method, a controller, while a printing press is printing on the web, receives a calculated untensioned product length Lₒ(t) of the web in the span of the printing press while the web is moving through the printing press under tension, compares L₀(t) to a previously stored untensioned product length setpoint Lₛₑₜₚₒᵢₙₜ, maintains closed loop control of the untensioned product length by controlling one or more components on the printing press as a function of said comparing step, and repeats the steps receiving, comparing, maintaining and controlling over time while the printing press is printing on the web.

The aforementioned embodiment may also include other optional components and features. For example:

In accordance with another aspect of the first embodiment, the printing press includes at least one printing unit having a plate cylinder, a blanket cylinder, and an impression cylinder, and the step of maintaining, may comprise varying an image velocity of the printing press by varying a rotational velocity of the plate and blanket cylinders. Further, the step of varying the image velocity may further include varying the image velocity while maintaining a relative image to web velocity to +/−0.15%.

In accordance with yet another aspect of the first embodiment, the at least one printing unit includes a plurality of printing units, each having a plate cylinder, a blanket cylinder, and an impression cylinder, and the step of varying includes synchronously varying all of the plate and blanket cylinders to maintain print register.

In accordance with yet another aspect of the first embodiment, the printing press includes a printing unit having a plate cylinder, a blanket cylinder, and an impression cylinder, and the step of maintaining comprises varying a web velocity of the printing press by varying a rotational velocity of the impression cylinder. Further, the step of varying the web velocity may further include varying the web velocity while maintaining a relative image to web velocity to +/−0.15%.

In accordance with yet another aspect of the first embodiment, the printing press includes an infeed and a printing unit downstream of the infeed having a plate cylinder, a blanket cylinder, and an impression cylinder, and the step of maintaining comprises varying a web velocity of the printing press by varying a web tension at the infeed.

In accordance with yet another aspect of the first embodiment, the controller or a different controller may, while a printing press is printing on the web, generate the calculated untensioned product length. The step of generating may include determining a tensioned repeat length of the web in a span of the printing press while the web is moving through the printing press under tension; determining an elastic strain of the web in the span of the printing press while the web is moving through the printing press under tension; and calculating an untensioned product length of the web in the span of the printing press while the web is moving through the printing press under tension as a function of the tensioned repeat length and the elastic strain.

In accordance with yet another aspect of the first embodiment, the step of determining the tensioned repeat length may comprise calculating the tensioned repeat length as a function of a reference repeat length and a velocity gain in the span.

In accordance with yet another aspect of the first embodiment, the step of determining the elastic strain may comprise measuring, with a sensor, a tension in the span, determining a stiffness of the web, and calculating the elastic strain as a function of the tension and the stiffness.

In accordance with yet another aspect of the first embodiment the step of calculating the untensioned product length may comprise calculating, during a production run, an untensioned product length L₀(t) over time t: L₀(t)=L₁(t)/(1+ε₁(t), where, at any given time t, L₀ is the untensioned product length, L₁ is the strained repeat length at the span, and ε₁ is the elastic strain of the web in the span; and wherein ε₁=T₁(t)/E(t), where T₁ is the tension at the span, and E is the web modulus.

In accordance with a second embodiment of the present invention, a web fed printing press for printing on a continuous web and cutting the web into printed products having an untensioned product length is provided. The press includes a printing unit including a plate cylinder, a blanket cylinder, and an impression cylinder. The press also includes a plurality of rollers located downstream of the printing unit. The web moves under tension through the printing unit and the plurality of rollers as it moves through the press. A controller is configured and arranged to control an untensioned product length of the web as it moves through a printing press under tension. The controller receives a calculated untensioned product length Lₒ(t) of the web in the span of the printing press while the web is moving through the printing press under tension, and compares L₀(t) to a previously stored untensioned product length setpoint Lₛₑₜₚₒᵢₙₜ. The controller maintains closed loop control of the untensioned product length by controlling one or more components on the printing press as a function of said comparing, and the controller repeats said receiving, comparing, maintaining and controlling over time while the printing press is printing on the web.

The aforementioned second embodiment may also include other optional components and features. For example:

In accordance with another aspect of the second embodiment, the maintaining may comprise the controller varying an image velocity of the printing press by varying a rotational velocity of the plate and blanket cylinders. Further, said varying the image velocity may further include the controller varying the image velocity while maintaining a relative image to web velocity to +/−0.15%.

In accordance with yet another aspect of the second embodiment, the press further comprises a second printing unit including a plate cylinder, blanket cylinder and impression cylinder, and said varying includes the controller synchronously varying the plate and blanket cylinders in the first and second printing units to maintain print register.

In accordance with yet another aspect of the second embodiment, said maintaining may comprise the controller varying a web velocity of the printing press by varying a rotational velocity of the impression cylinder. Further, said varying the web velocity may further include the controller varying the web velocity while maintaining a relative image to web velocity to +/−0.15%.

In accordance with yet another aspect of the second embodiment, the printing press includes an infeed, and said maintaining comprises the controller varying a web velocity of the printing press by varying a web tension at the infeed.

In accordance with yet another aspect of the second embodiment, the controller or a different controller is configured and arranged to generate the calculated untensioned product length while a printing press is printing on the web. The controller or the different controller determines a tensioned repeat length of the web in a span of the printing press while the web is moving through the printing press under tension; determines an elastic strain of the web in the span of the printing press while the web is moving through the printing press under tension; and calculates an untensioned product length of the web in the span of the printing press while the web is moving through the printing press under tension as a function of the tensioned repeat length and the elastic strain.

In accordance with yet another aspect of the second embodiment, the press includes a sensor configured and arranged to measure a tension in the span, and said determining the elastic strain comprises the controller determining a stiffness of the web, and calculating the elastic strain as a function of the tension and the stiffness.

### BRIEF DESCRIPTION OF THE DRAWINGS

The present invention will be further described with respect to the following Figures, in which:

FIG. 1a illustrates a printing press in accordance with an embodiment of the present invention including an untensioned product length measurement system.

FIG. 1b shows a capstan roller arrangement which may be provided as an alternative to non-slip roller pair 600 and/or 900 of FIG. 1A.

FIG. 2 shows a printing press in accordance with an embodiment of the present invention including a closed loop untensioned product length control system.

### DETAILED DESCRIPTION OF PREFERRED EMBODIMENTS OF THE INVENTION

As explained above, in order to control the untensioned product length it must first be measured. In today's industry, the untensioned product length is sometimes measured directly. This can be accomplished by cutting a sample from the web, laying it out flat and untensioned on a table, and measuring it with a mechanical or video measurement system. Theoretically, it is also possible to measure the untensioned length of a printed product in the press by setting a span to zero tension and taking a direct measurement. This could be done with a static web or, under special circumstances, a moving web.

As noted above, attempts have also been made to define the untensioned product length by estimating the amount that a given substrate will “snap back” when process tensions are removed.

As also explained above, the TecScan Web Ranger system claims to “display in real time print length measurements of every repeat”. TecScan Web Ranger Brocure (2005). Although the details of the TecScan Web Ranger system are unknown to applicant, it is believed that in this system a precision shaft encoder is the only measurement hardware on the press. Assuming no slip between the web and roller, this type of system could theoretically measure the local web speed. The web speed multiplied by repeat time (if known) can generate the strained repeat length in the measurement span. Accordingly, even if this system works as described, it is believed to at most be able to approximate the repeat length of a strained (tensioned) web only. The accuracy of this measurement of strained (tensioned) repeat length is dependent on the accuracy of those two variables.

Direct, off-line measurements of the untensioned product length can be used as a QC (Quality Control) tool but can be time consuming and difficult to perform accurately. To perform a measurement, the web is stopped and a sample must be cut out. The sample is then transported to a measurement area where it can be laid out flat and smooth. Care must be taken not to wrinkle or stretch the material. Since this is an offline measurement, it cannot be used for feedback in a control system.

Measuring the untensioned product length in the press presents its own set of problems. First, the web must be printed. However, not all products in which repeat length is a concern are printed. Second, the web cannot be transported at zero tension in a typical web press operation. Attempts to do so can result in wrinkling and/or web-weave, especially with thin, low stiffness substrates. Third, even where it is possible to transport a web at zero tension, the speed will be limited. Since these in-press measurements cannot be performed under normal production conditions they cannot be used as feedback in a control system.

Estimating the untensioned product length based on an amount of snap-back that is assumed for a given material or job will provide only a rough approximation of the untensioned product length. The actual snap-back is a function of both the process tensions, and a web modulus that can vary significantly within a job. This method also assumes that the amount of plastic strain introduced in the production process is known (it is most likely assumed to be zero), and this may not be the case. Further, this type of estimate would provide information for one adjustment only, and cannot be used as feedback in a control system.

Real-time feedback is required for real-time process control. The TecScan Web Ranger system can provide a real-time signal proportional to local web velocity, but cannot provide the untensioned product length. No attempts to provide a measurement that could be used as feedback in an untensioned product length control system are known to the applicants.

In the flexible packaging, the control of unstrained repeat length is important. Real-time process control would be a significant value-added feature and real-time feedback is necessary for this control.

The existing methods of providing unstrained repeat length feedback use either an estimated snap-back (which can be inaccurate), or interrupt the production process and measure it directly (which should be more accurate, but is difficult and slow).

In accordance with various embodiments of the present invention, the untensioned repeat length can be accurately defined and controlled while the press is running. Real-time, untensioned repeat length feedback will enable process control in production. Closed-loop control would allow the repeat length to be maintained without operator intervention. As used in the art, the term “repeat length” refers to the length of printed image(s) in a rotary printing press before they repeat. In a typical rotary press, the “repeat length” corresponds to the circumference of the plate cylinder, and is sometimes also referred to as the “cut-off” of the press. Since the web onto which the images are printed is elastic, the repeat length of the plate cylinder (reference repeat length) will differ from the repeat length of the printed web under tension (tensioned or strained repeat length) which in turn will differ from the repeat length of the printed sheets after the web is cut into sheets (untensioned repeat length or untensioned product length). As used herein, the term untensioned repeat length and untensioned product length are used interchangeably, as are the terms tensioned repeat length and strained repeat length.

In the preferred embodiment, both the product's repeat length (under tension) and the strain in the web are defined in a span toward the end of the press. The strain in the product is then mathematically removed to define the untensioned repeat length during a production run. The physics and mathematics that can be used to provide the untensioned repeat length are summarized below. However, as an initial, matter, it is helpful to provide an overview of the process from an engineering perspective and from a pressman's perspective.

From an engineering perspective, a product's untensioned repeat length can be calculated in accordance with the various embodiments of the present invention by defining its tensioned repeat length in a span, then mathematically removing the elastic strain in that span. The tensioned repeat length can be calculated by applying all of the gains in the measurement span to the reference repeat length (cut off). The elastic strain in the measurement span can be defined if the web's tension and its stiffness are known. The tension is a direct measurement. The stiffness can be defined by measuring the web tensions at two different gains. The untensioned repeat length can be adjusted by changing the relative velocity of the image and the web.

Viewed instead from the perspective of a pressman, a product's untensioned repeat length can be calculated in accordance with the various embodiments of the present invention by finding its repeat length under tension, then subtracting the amount that it will snap back when the tension is released. The repeat length in a span under tension can be calculated if the repeat length at the printing unit (the cut off) and the velocity of the web in that span are known. The amount that a repeat length will snap back can be found with knowledge of both the web's tension and how stiff the web is. The tension is measured in the press with sensors. The web's stiffness can be found by stretching it two different amounts and measuring the two different tensions that result. The untensioned repeat length can be adjusted by changing how much web passes each time that an image is laid down.

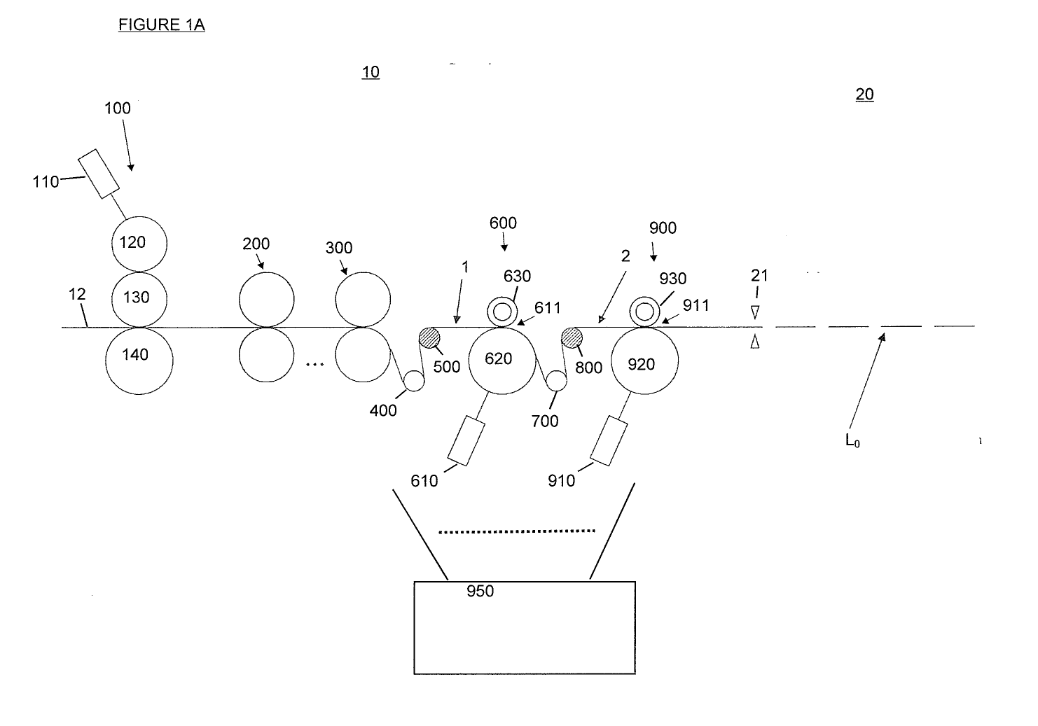

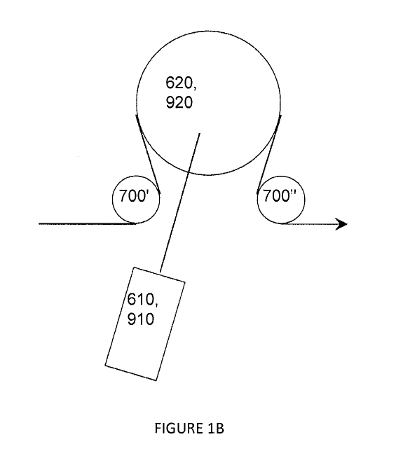

FIG. 1a illustrates a printing press 10 which includes a printing unit 100 printing on a web 12. Printing unit 100 includes a drive 110, a plate cylinder 120, a blanket cylinder 130, and an impression cylinder 140. Impression cylinder is a hard cylinder having an outer surface made, for example, of metal such as steel or aluminum. Blanket cylinder 130 carries a printing blanket having an outer layer made of an elastomeric material such as natural or synthetic rubber. Plate cylinder 120 holds the image carrier, for example, a printing plate. Although a single printing unit 100 is shown, it should be understood that additional printing units 100 may also be provided upstream of printing unit 100. Drive 110 may be a single motor which drives plate cylinder, blanket cylinder and impression cylinder, or may include more than one motor such that each cylinder is driven by a different motor, or two of the cylinders are driven by one motor, and the third driven by a different motor. Although an individual motor is shown for each printing unit, it should be appreciated that as an alternative, a line shaft can be used to drive all printing units from a single motor. The time it takes for each repeat length to print is: tᵣₑₚₑₐₜ=2π/ω), where ω is the rotational speed of the cylinder 120 in radians per second.

The printing press 10 may also include other subsequent processes 200, 300, which may for example, include a dryer, a chill roll stand, slitters, and angle bars for example. After the optional processes 200, 300, the web 12 passes through an Idler roller 400 and a tensioning roller 500. Tensioning roller 500 measures the tension in the web as is known in the art. From the tensioning roller 500, the web 12 passes through a nip 611 formed between rollers 620 and 630 of non-slip roller pair 600. A motor 610 drives roller 620. Motor 610 is preferably a servomotor. Roller 620 is preferably a hard roller and roller 630 is preferably a soft idler roller in order to form a non-slip nip. Typically, roller 620 would be made of a metal such as aluminum or steel, whereas roller 630 typically has an elastomeric coating made for example of natural or synthetic rubber. Span 1 is defined as the segment of the web 12 between roller 500 and nip 611. Span 1 has a tension T₁, a strained velocity V₁, a strained repeat length L₁ and a web thickness h. Motor 610 applies a gain relative to the reference velocity V_{ref} of the press based on a number of factors. In this example, the gain is based on two factors: α₁, a drive setpoint for transport gains for tension T; and β₁, a drive setpoint for transport gains for repeat length L₁. As one of ordinary skill in the art will appreciate, α and β are setpoints that are used in the art to program the motor 610. As explained below, V₁ is a function of Vref, α₁, and β₁, as well as h (web thickness), and R₁ (the radius of roller 620). Alternatively, it is possible to directly measure V₁ based, for example, on the rotational speed of the motor 620 as measured by an encoder or resolver.

After exiting nip 611, the web 12 passes over an idler roller 700 and a tensioning roller 800. From the tensioning roller 800, the web 12 passes through a nip 911 formed between rollers 920 and 930 of non-slip roller pair 900. A motor 910 drives roller 920. Motor 910 is preferably a servomotor, and drives roller 920 in the same manner described above as a function of α₂ and β₂. Roller 920 is preferably a hard roller and roller 930 is preferably a soft idler roller in order to form a non-slip nip. Typically, roller 920 would be made of a metal such as aluminum or steel, whereas roller 930 typically has an elastomeric coating made for example of natural or synthetic rubber. Span 2 is defined as the segment of the web 12 between roller 800 and nip 911. Span 2 has a tension T₂, a strained velocity V₂, a strained repeat length L₂ and web thickness h. Downstream of the nip 911 the web is eventually cut as is known in the art. It should be understood that it may be cut on-line with a folder, or may be cut-off line in any other manner. In any event, after being cut from the web, the sheets will have an untensioned repeat length L₀.

Although non-slip roller pairs are preferred, alternatively, rollers 620, 630 (and/or rollers 920, 930) could be replaced with a single hard roller arranged to provide a non-slip condition with a capstan wrap as shown in FIG. 1b. In FIG. 1B, a capstan wrap is implemented over roller 620 (or 920) via a pair of idler rollers 700′, 700″.

The strained repeat length is calculated by applying known modifications to the reference repeat length (also commonly referred to in the art as the cut-off). These modifications include the velocity gains (α1, β1, or α2, β2) that are applied to a downstream motor (610 or 910) that controls the web velocity in the span (1 or 2) of interest. Another modification accounts for the effect of a web's thickness (h) on the “pitch line” of web over the roll that controls its velocity. These modifications can be readily and accurately determined for a given print job on a given press. When employing servo drives as motors (610 or 910), the gains can be the exact setpoints that are used to control the servo drives. Any error in the web's “pitchline modification” will be very small because the modification is (h/2)/R₁: half of a very small number (the web's thickness, h) divided by a relatively large number (the driven roll's radius R₁). The strain in the span is calculated by dividing the web's tension in the span by its modulus (ε₁=T₁/E). In the preferred embodiment, the span's tension is measured directly using any number of commercially available technologies. In FIG. 1, for example, a tensioning roller 500 is used for span 1, and a tensioning roller 800 is used for span 2. In the preferred embodiment, the web's modulus is determined by dividing the tension differential in two different spans by the strain differential in these two spans (E=ΔT/Δε). The strain differential, in turn, is determined from velocities V₁, V₂, and V_{ref} as follows: Δε=(V₂−V₁)/V_{ref}. Since the tension and strain measurements can all be taken during a production run, the modulus (E) can be calculated during a production run. This can be important since the modulus is known to vary both within a roll and from one roll to the next of the same nominal web. The untensioned product length can then be calculated during a production run as L₀(t)=L₁(t)/1+T₁(t)/E(t), where, at any given time t, L₀ is the untensioned product length, L₁ is the strained repeat length at span 1, T₁ is the tension at span 1, and E is the calculated modulus E. Accurate feedback of the untensioned product length can be provided during production using the procedures outlined above.

Other embodiments, alternatives, and enhancements can also be provided. The strained product length can be measured directly using a camera or cameras. These measurement systems are available in the printing industry. The strained repeat or product length can also be calculated by measuring the web velocity and multiplying it by the time to generate a repeat (for example, one image cylinder revolution). The web velocity can be measured directly using any number of devices, such as laser velocity sensors, or indirectly using a precision encoder and non-slipping idler roll. Depending on the substrate's consistency and the process requirements, the web thickness can be a one-time operator input or a real-time measurement. Real-time web thickness measurement systems are readily available. In the preferred embodiment described above, the web's modulus is defined by dividing the tension differential in two different spans by the strain differential in these two spans. The web's modulus can also be defined by recording the tensions at two different strains in the same span. This however would not provide a real-time modulus value. The modulus could also be an operator input or pulled from a previously established look up table.

An untensioned repeat length generator generates a calculated untensioned repeat length over time, L₀(t). As one of ordinary skill in the art will appreciate, calculation of the untensioned repeat length over time L₀(t), may for example, be performed by computer, processor, or PLC executing software. Alternatively, it could be implemented entirely in hardware, for example, as an ASIC (“application-specific integrated circuit”), FPLD (“Field-Programmable Logic Device”), or otherwise implemented in discrete hardware. As used herein, the term controller is defined as encompassing any and all of the forgoing, including a controller which comprises one or more computers, processors, or PLCs executing software; a controller which is implemented entirely in hardware, for example, as an ASIC, FPLD, or other discrete hardware; as well as combinations of the forgoing. FIG. 1 illustrates such a controller 950, which generates the calculated untensioned repeat length over time, L₀(t). In the example of FIG. 1, generator 950 would receive inputs over time (t) from the tensioning rollers 500 and 800, and would also receive the velocity gains (α1, β1, α2, β2) that are applied to a downstream drives 610, 910). Individual connections are omitted for ease of illustration, but as one of ordinary skill in the art will appreciate, the velocity gains could be received either from the drives themselves, or for example, from a control system providing the velocity gains to the drives.

The following is a non-limiting example of how untensioned repeat length can be determined during production on the system of FIG. 1a:

Variables

1. Constants: R₁=Radius of roller 620
R₂=Radius of roller 920

2. From Job Data for press:
CO_{REF}=Reference repeat length
h=Web Thickness

3. Drive set point values for drives 610, and 910:
α₁, α₂ Transport Gains for Tension in span 1 and 2 respectively
β₁, β₂ Transport Gains for Repeat Length in span 1 and 2 respectively

4. Transducer feedback:
T₁=Tension in Span 1
T₂=Tension in Span 2

From these variables, the untensioned repeat length can be determined during production on the system of FIG. 1a, as illustrated below:

L₁=L₀(1+ε₁), A)
where L₀=Untensioned Repeat length, ε₁=Strain at span 1, and L₁=Tensioned Repeat Length at Strain 1

L₀=L₁/(1+ε₁) B)

L1 is defined as L1=(t_{REPEAT}) (V1), where t_{REPEAT}=time for the plate to print one full plate revolution image, and V₁=Web Velocity 1, yielding:

L₁=(2π/ω_{REPEAT})(V_{REF}(1+α1)(1+β1)(1+(h/2)/(R1)) C)

V_{REF}=(ω_{REPEAT})(R_{REF}) D)

Subbing D into C and cancelling ω_{REPEAT} yields:

L₁=(2πR_{REF})(1+α₁)(1+β₁)(1+(h/2)/R₁) E)

CO_{REF}=2πR_{REF}, F)
where CO_{REF}=Reference Repeat, for example 700 mm.

Subbing F into E yields:

L₁=CO_{REF}(1+α₁(1+1β₁)(1+(h/2)/R₁) G)

ε₁ is defined as follows:

ε₁=T₁/E, H)
where E=Web Modulus

Subbing G and H into B yields:

L₀=(CO_{REF}(1+α₁)(1+β₁)(1+(h/2)/R₁))/(1+T₁/E) J)

The web modulus E can be calculated as

$$\begin{matrix}E = \frac{Δ T}{Δɛ} & K ) \\ Δɛ = \frac{{V}_{2} - {V}_{1}}{{V}_{REF}} & L )\end{matrix}$$

Δε=(V_{REF}(1+α₂)(1+β₂)(1+(h/2)/R₂)−(1+α₁)(1+β₁)(1+(h/2)/R₁))/V_{REF} M)

Δε=(1+α₂)(1+β₂)(1+(h/2)/R2)−(1+α₁)(1+β₁)(1+(h/2)/R₁) N)

ΔT=T₂−T₁ P)

Subbing N & P into K yields:

$$E = \frac{{T}_{2} - {T}_{1}}{( 1 + {∝}_{2} ) ( 1 + {β}_{2} ) ( 1 + \frac{h / 2}{{R}_{2}} ) - ( 1 + {∝}_{1} ) ( 1 + {β}_{1} ) ( 1 + \frac{h / 2}{{R}_{1}} )} \qquad Q )$$

Finally, subbing Q into J yields the untensioned repeat length L₀.

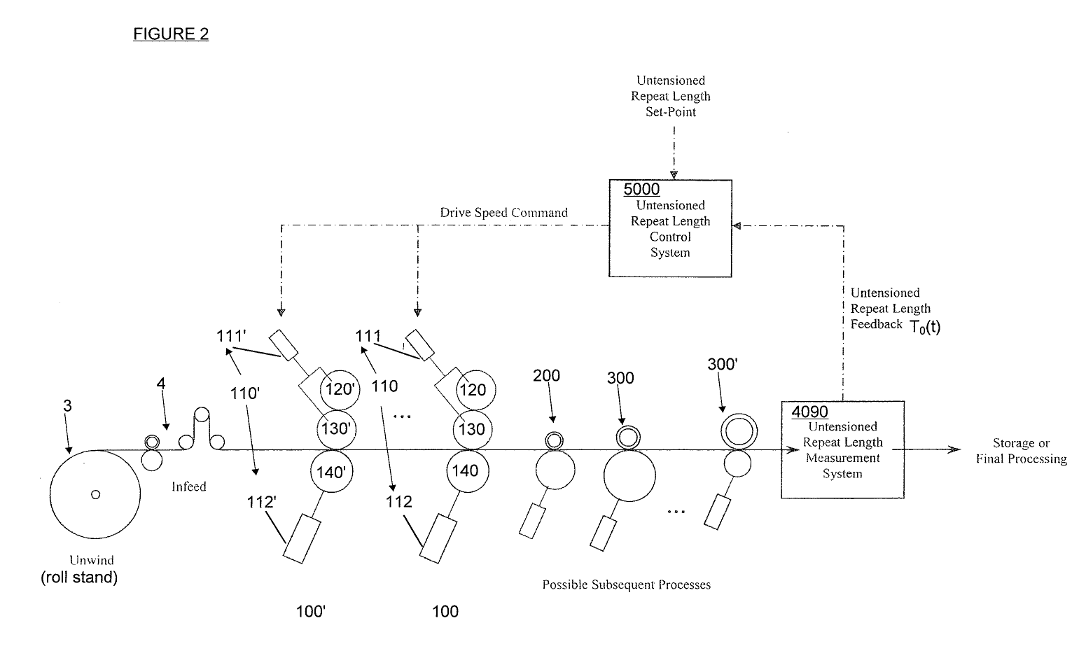

FIG. 2 illustrates a closed loop untensioned repeat length measurement system, with similar components bearing similar reference numerals to FIG. 1. Printing press 10 includes a roll stand with web roll 3, an infeed 4, and printing units 100′ and 100, and optional subsequent processes 200, 300, 300′. In the example of FIG. 2, each drive (110, 110′) includes an image cylinder motor (111, 111′) driving plate (120, 120′) and blanket (130, 130′) cylinders, and an impression cylinder motor (112, 112′) driving the impression cylinder (140, 140′). Untensioned repeat length measurement system 4090 may comprise components 400 through 950 of FIG. 1, or may alternatively be any system which generates an untensioned repeat length L₀(t) as a function of time t during a production run.

Untensioned repeat length controller 5000 receives as input the current, calculated untensioned repeat length L₀(t) from measurement system 4090, and an untensioned repeat length set-point Lₛₑₜₚₒᵢₙₜ. Lₛₑₜₚₒᵢₙₜ may, for example, be input from a user via a user-interface such as a keyboard, mouse, or touchscreen. Alternatively, Lₛₑₜₚₒᵢₙₜ may be input from values stored in memory, for example, a preset value for a given print job. In any case, control system 5000 compares L₀(t) and Lₛₑₜₚₒᵢₙₜ to calculate an error signal. The controller 5000 then uses the error signal to provide commands to a system or systems on the press to achieve closed loop control of the untensioned repeat length. In this regard, the error signal corresponds to a difference between L₀(t) and Lₛₑₜₚₒᵢₙₜ, and the controller provides commands to system(s) on the press to eliminate this difference within tolerances defined by the user, manufacturer or installer. Systems that could be controlled to adjust the untensioned repeat length include: (1) the infeed 4 (e.g., controlling the initial web strain through control of infeed tension), (2) the Impression Cylinder drives 112′, 112 (controlling web velocity via impression cylinder velocity) relative to the Image drives 111′, 111; or (3) the Plate & Blanket Cylinder drives 111′, 111 (controlling image velocity via plate and blanket cylinder velocity) relative to the web drives 112′, 112. With regard to the foregoing, as one of ordinary skill in the art will appreciate, since the impression cylinder is a hard cylinder, the web “sticks” to the impression cylinder and the surface speed of the impression cylinder defines the web speed.

In a preferred embodiment, all plate and blanket cylinder velocities will be acted upon and controlled synchronously to maintain print registers. Changing the relative image-to-web velocity will change the untensioned repeat length. Within limits, web transport will not be affected by the modifications to the plate and blanket cylinder velocities. The amplitude of the relative image-to-web velocity is preferably limited to avoid print quality concerns such as elongated dots. In particular, it is preferable to limit the relative image-to-web velocity to +/−0.15%.

In an alternative embodiment, the infeed can be used to control the untensioned repeat length by controlling the web strain at the infeed, as described, for example in commonly owned U.S. application Ser. No. 13/595,008, entitled Strain Controlled Infeed.

As one of ordinary skill in the art will appreciate, controller 5000, may for example, be computer(s), processor(s), or PLC(s) executing software. Alternatively, it could be implemented entirely in hardware, for example, as an ASIC (“application-specific integrated circuit”), FPLD (“Field-Programmable Logic Device”), or otherwise implemented in discrete hardware. Further controller 5000 may itself include controller 950. Moreover, both controller 5000 and controller 950 may form part of a press control system that controls other or all press functions. The press control system, in turn, may comprise computer(s), processor(s), or PLC(s) executing software, or could itself be implemented entirely in hardware.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A method for providing closed loop control of an untensioned product length of a web moving through a printing press under tension during production, comprising, using a controller:
while a printing press is printing on the web:
receiving a calculated untensioned product length Lₒ(t) of the web in the span of the printing press while the web is moving through the printing press under tension,
comparing L₀(t) to a previously stored untensioned product length setpoint Lₛₑₜₚₒᵢₙₜ,
maintaining closed loop control of the untensioned product length by controlling one or more components on the printing press as a function of said comparing step, and
repeating the steps receiving, comparing, maintaining and controlling over time while the printing press is printing on the web.

2. The method of claim 1, wherein the printing press includes at least one printing unit having a plate cylinder, a blanket cylinder, and an impression cylinder, and wherein the step of maintaining, comprises varying an image velocity of the printing press by varying a rotational velocity of the plate and blanket cylinders.

3. The method of claim 2, wherein the step of varying the image velocity further includes varying the image velocity while maintaining a relative image to web velocity to +/−0.15%.

4. The method of claim 1, wherein the at least one printing unit includes a plurality of printing units, each having a plate cylinder, a blanket cylinder, and an impression cylinder, and wherein the step of varying includes synchronously varying all of the plate and blanket cylinders to maintain print register.

5. The method of claim 1, wherein the printing press includes a printing unit having a plate cylinder, a blanket cylinder, and an impression cylinder, and wherein the step of maintaining comprises varying a web velocity of the printing press by varying a rotational velocity of the impression cylinder.

6. The method of claim 5, wherein the step of varying the web velocity further includes varying the web velocity while maintaining a relative image to web velocity to +/−0.15%.

7. The method of claim 1, wherein the printing press includes an infeed and a printing unit downstream of the infeed having a plate cylinder, a blanket cylinder, and an impression cylinder, the step of maintaining, comprises varying a web velocity of the printing press by varying a web tension at the infeed.

8. The method of claim 1, further comprising, using the controller or a different controller:
while a printing press is printing on the web, generating the calculated untensioned product length, wherein the step of generating further includes:
determining a tensioned repeat length of the web in a span of the printing press while the web is moving through the printing press under tension;
determining an elastic strain of the web in the span of the printing press while the web is moving through the printing press under tension; and
calculating an untensioned product length of the web in the span of the printing press while the web is moving through the printing press under tension as a function of the tensioned repeat length and the elastic strain.

9. The method of claim 8, wherein the step of determining the tensioned repeat length comprises calculating the tensioned repeat length as a function of a reference repeat length and a velocity gain in the span.

10. The method of claim 8, wherein the step of determining the elastic strain comprises
measuring, with a sensor, a tension in the span,
determining a stiffness of the web, and
calculating the elastic strain as a function of the tension and the stiffness.

11. The method of claim 8, wherein the step of calculating the untensioned product length comprises
calculating, during a production run, an untensioned product length L₀(t) over time t:
L₀(t)=L₁(t)/(1+ε₁(t)), where, at any given time t, L₀ is the untensioned product length, L₁ is the strained repeat length at the span, and ε₁ is the elastic strain of the web in the span;
and wherein ε₁=T₁(t)/E(t), where T₁ is the tension at the span, and E is the web modulus.

12. A web fed printing press for printing on a continuous web and cutting the web into printed products having an untensioned product length, the press comprising:
a printing unit including a plate cylinder, a blanket cylinder, and an impression cylinder;
a plurality of rollers located downstream of the printing unit, the web moving under tension through the printing unit and the plurality of rollers as it moves through the press;
a controller configured and arranged to control an untensioned product length of the web as it moves through a printing press under tension, the controller receiving a calculated untensioned product length Lₒ(t) of the web in the span of the printing press while the web is moving through the printing press under tension, the controller comparing L₀(t) to a previously stored untensioned product length setpoint Lₛₑₜₚₒᵢₙₜ, the controller maintaining closed loop control of the untensioned product length by controlling one or more components on the printing press as a function of said comparing, and the controller repeating said receiving, comparing, maintaining and controlling over time while the printing press is printing on the web.

13. The press of claim 12, wherein the maintaining, comprises the controller varying an image velocity of the printing press by varying a rotational velocity of the plate and blanket cylinders.

14. The press of claim 13, wherein said varying the image velocity further includes the controller varying the image velocity while maintaining a relative image to web velocity to +/−0.15%.

15. The press of claim 12, further comprising a second printing unit including a plate cylinder, blanket cylinder and impression cylinder, and wherein said varying includes the controller synchronously varying the plate and blanket cylinders in the first and second printing units to maintain print register.

16. The press of claim 12, wherein said maintaining comprises the controller varying a web velocity of the printing press by varying a rotational velocity of the impression cylinder.

17. The press of claim 16, wherein said varying the web velocity further includes the controller varying the web velocity while maintaining a relative image to web velocity to +/−0.15%.

18. The press of claim 1, wherein the printing press includes an infeed, and wherein said maintaining comprises the controller varying a web velocity of the printing press by varying a web tension at the infeed.

19. The press of claim 1, further comprising, the controller or a different controller configured and arranged to generate the calculated untensioned product length while a printing press is printing on the web, the controller or the different controller
determining a tensioned repeat length of the web in a span of the printing press while the web is moving through the printing press under tension;
determining an elastic strain of the web in the span of the printing press while the web is moving through the printing press under tension; and
calculating an untensioned product length of the web in the span of the printing press while the web is moving through the printing press under tension as a function of the tensioned repeat length and the elastic strain.

20. The press of claim 19, further comprising a sensor configured and arranged to measure a tension in the span, and wherein said determining the elastic strain comprises the controller determining a stiffness of the web, and calculating the elastic strain as a function of the tension and the stiffness.
